(19) United States
(12) Patent Application Publication
(10) Pub. No.: US 2004/0221626 A1
(43) Pub. Date: Nov. 11, 2004

(54) Security cover with releasable lock

(76) Inventors: Raymond G. Palzkill, Elkhorn, NE (US); Keith R. Feilmeier, Omaha, NE (US)

Correspondence Address: George R. Nimmer, PO Box 252, Omaha, NE, 68101-0252, US

(21) Appl. No.: 10/647,994

(22) Filed: Aug. 26, 2003

Related U.S. Application Data
(60) Provisional application No. 60/406,480, filed on Aug. 28, 2002.

(51) Int. Cl. E05B 67/36; E05B 13/00

(52) U.S. Cl. 70/34; 70/211

(57) ABSTRACT

A security cover with releasable lock includes a rearwardly opening steel box secured over the ears of a hasp assembly on a cargo container, with the hasp ears positioned within the box. An operable lock is mounted on the box, for selectively securing the hasp ears by the selective positioning of a pin through the ears of the hasp within the box. In the preferred embodiment, the lock is a plunger type lock with a plug connected to the pin and operable to selectively slide the pin into journaled engagement with the hasp ears.

### CROSS-REFERENCES TO RELATED APPLICATIONS

Applicant claims the benefit of U.S. Provisional Application Ser. No. 60/406,480, filed Aug. 28, 2002.

### STATEMENT AS TO RIGHTS TO INVENTIONS MADE UNDER FEDERALLY SPONSORED RESEARCH AND DEVELOPMENT

(Not applicable)

### BACKGROUND OF THE INVENTION

(1) Field of the Invention

The present invention relates generally to apparatus for securing the latch or hasp assembly of shipping containers, truck doors and the like, and more particularly to an improved releasable lock and security cover for latch and hasp assemblies for preventing unauthorized access to a container.

(2) Background Information

Shipping containers are widely used in the transportation of various types of goods, both domestically and internationally. However, the task of securing such containers against break-ins has proven difficult to solve.

Prior art attempts include such devices as hasp protectors and various bolt seals. For example, U.S. Pat. No. 5,118,149 discloses a container hasp protector with a metal box with an open rearward side. A shield plate on the front face extends between the sides to form upper and lower openings in the face between the shield plate and the top and bottom walls of the box. The box encloses the container's hasp, to protect against damage by a thief.

Although this apparatus provides protection for the hasp, it still leaves the shank of the security seal/pin open for tampering or cutting, through the openings in the front face.

Similarly, padlock-type security devices such as those disclosed in U.S. Pat. Nos. 5,477,710, 5,146,771 and 4,898,008 suffer the problem of exposure of the shanks or shackles to bolt-cutters or other shears.

U.S. Pat. Nos. 6,010,166, 6,009,731 and 6,036,240 all disclose bolt seal lock devices that utilize a pin with an enlarged head on an upper end and a lock body on a lower end, the shank of the pin journaled though aligned apertures in a housing to cover a portion of a keeper bar and prevent operation of the keeper bar while the cover is in place. However, each of these devices incorporates an enlarged locking body which is preferably releasable, and exposed on one side. The exposed locking body of such apparatus can therefore be accessed by unauthorized persons, and potentially permit tampering and prying of the locking body off the shank of the pin.

### BRIEF SUMMARY OF THE INVENTION

It is therefore a general object of the present invention to provide an improved releasable lock and security cover for cargo containers.

Yet another object is to provide an improved lock for a cargo latch that encloses the lock body within the cover when in the locked position.

These and other objects of the present invention will be apparent to those skilled in the art.

The releasable lock and security cover of the present invention includes a rearwardly opening steel box secured over the ears of a hasp assembly on a cargo container, with the hasp ears positioned within the box. An operable lock is mounted on the box, for selectively securing the hasp ears by the selective positioning of a pin through the ears of the hasp within the box. In the preferred embodiment, the lock is a plunger type lock with a plug connected to the pin and operable to selectively slide the pin into journaled engagement with the hasp ears.

### BRIEF DESCRIPTION OF THE SEVERAL VIEWS OF THE DRAWING

The preferred embodiment of the invention is illustrated in the accompanying drawings, in which similar or corresponding parts are identified with the same reference numeral throughout the several views, and in which:

FIG. 1 is a perspective view of the security cover of the present invention with the cover ready for installation on a cargo container latch;

FIG. 2 is a perspective view of the interior of the cover;

FIG. 3 is a top plan view of the security cover installed on a cargo container latch;

FIG. 4 is a cross-sectional view taken at lines 4-4 in FIG. 3;

FIG. 5 is a perspective view of the security cover ready for installation on a second embodiment of a hasp assembly; and

FIG. 6 is a top plan view of the security cover installed on the second embodiment of the hasp assembly, shown in FIG. 5.

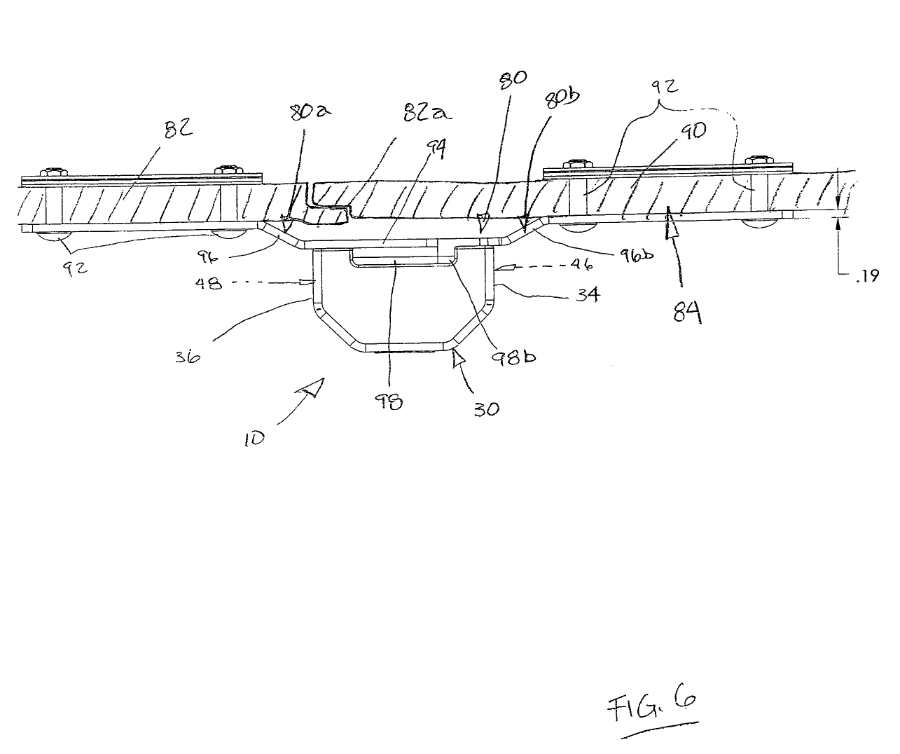

### DETAILED DESCRIPTION OF THE INVENTION

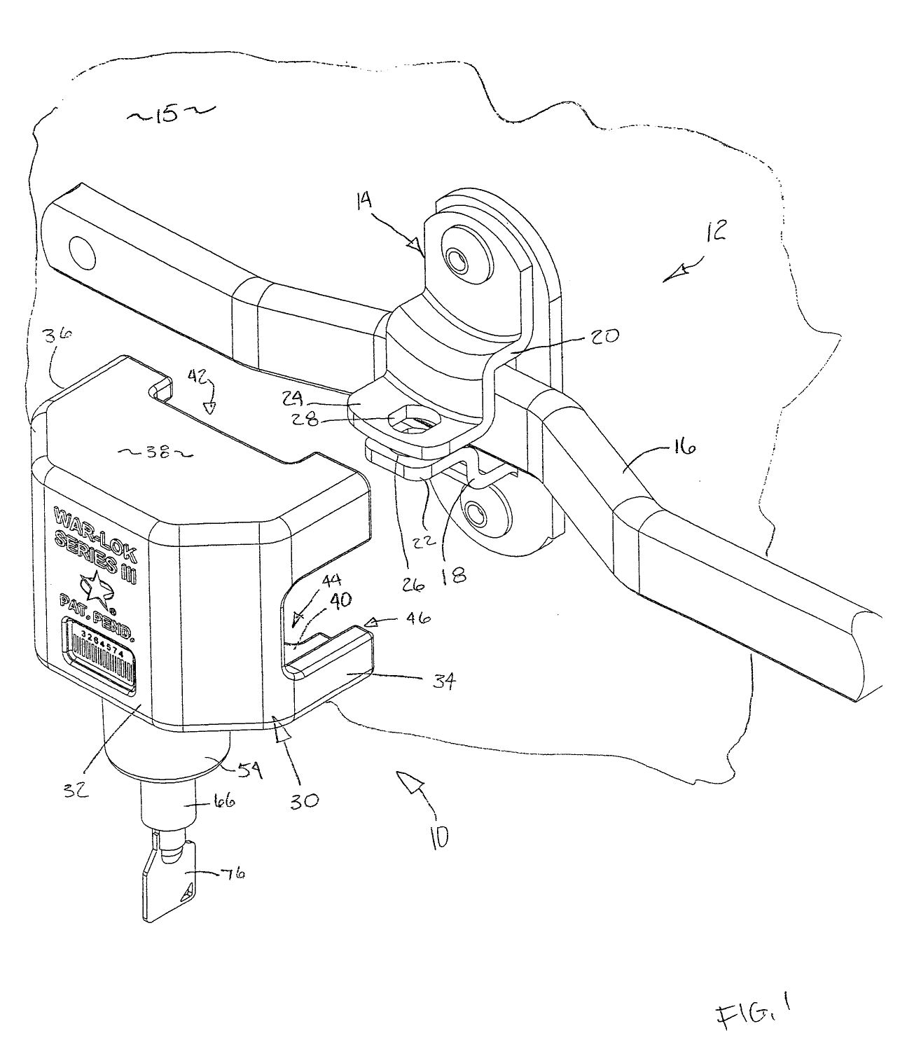

Referring now to the drawings and more particularly to FIG. 1, the security cover with releasable lock of the present invention is designated generally at 10 and is shown ready for installation on a cargo container latch, designated generally at 12.

Latch 12 is shown in the drawings as a conventional hasp 14 for securing the handle 16 of a conventional keeper bar (not shown) on a door of a shipping container 15. Hasp 14 is of a conventional variety, having a stationary leg 18 and a pivoting leg 20. Each leg 18 and 20 has a projecting ear 22 and 24, respectively, with aligned apertures 26 and 28, respectively. In the prior art, a padlock, or similar securement device was secured to the ears 22 and 24 to prevent movement of the handle 16 from hasp 14. The present invention replaces such securement devices with the security cover 10 of the present invention, as described in more detail hereinbelow.

Security cover 10 is a rearwardly opening box 30 of sheet steel, including a front wall 32, opposing sidewalls 34 and 36 and opposing top and bottom walls 38 and 40. The open portion of box 30 faces rearwardly to cover hasp 14, when cover 10 is secured in position. Top and bottom walls 38 and 40 each include an opening 42 and 44, respectively, which are vertically aligned and located at the rearward edge of box 30, to receive legs 20 and 18, respectively, therethrough. In this way, hasp ears 22 and 24 project within the interior of box 30 when cover 10 is secured to hasp 14, with the rearward edge of the box walls in generally abutting contact with the front surface of the cargo container 15.

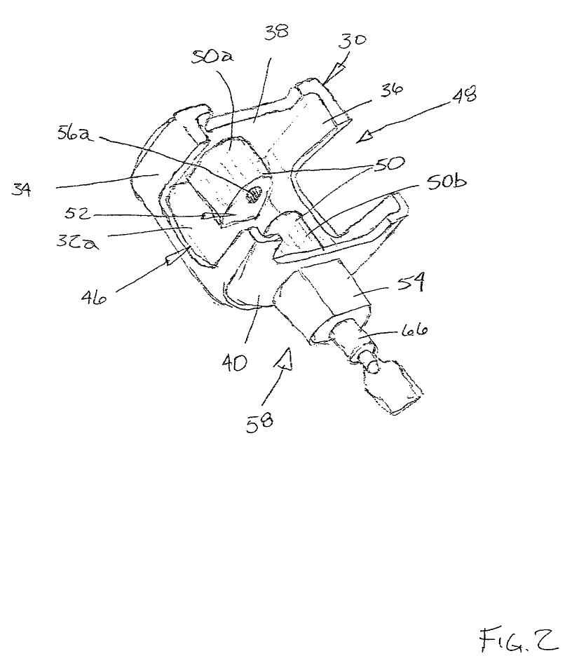

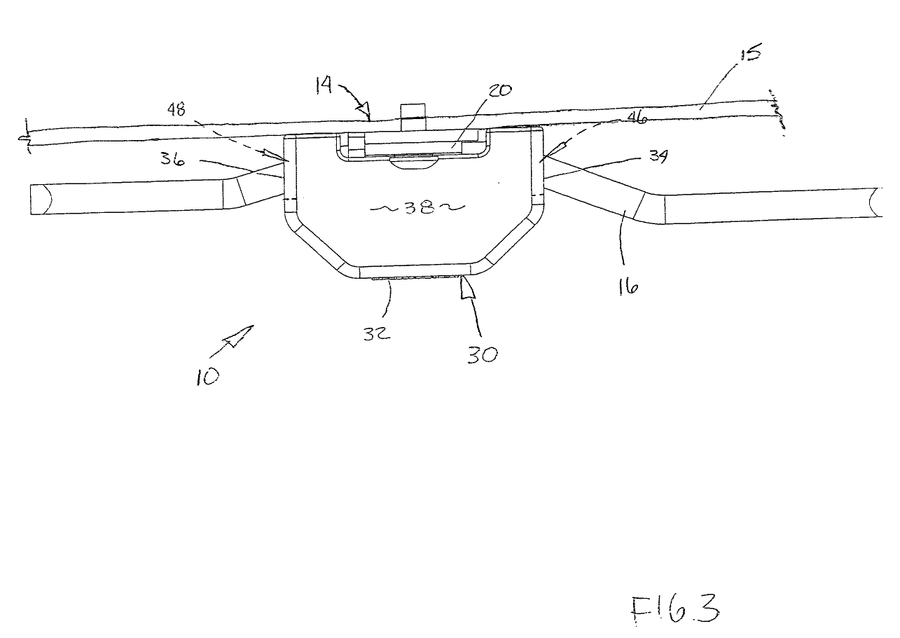

Each of sidewalls 34 and 36 also have an opening 46 and 48 (also shown in FIGS. 2 and 3), respectively, which are horizontally aligned and located at the rearward edge of box 30, to receive handle 16 (see FIG. 1) therethrough when cover 10 is secured to hasp 14. Openings 46 and 48 receive handle 16, so that the rearward edge of the box walls are in generally abutting contact with the front surface of cargo container 15 when cover 10 is secured in place.

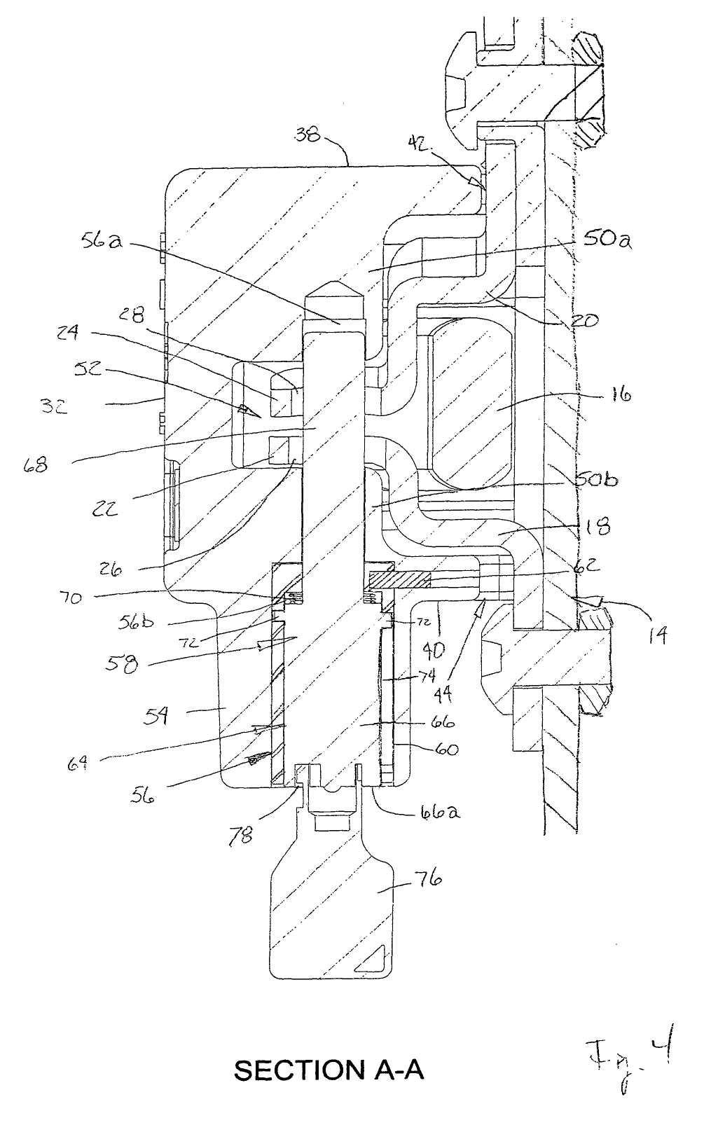

Referring now to FIG. 2, the interior of box 30 is shown in more detail. As noted above, the interior of box 30 will hold and cover the entirety of hasp leg ears 22 and 24 (shown in FIG. 1), and a large portion of hasp legs 18 and 20. A vertically oriented ridge 50 of steel is formed on the inward face 32a of forward wall 32, and has a centrally located, horizontal break 52 therethrough, to form an upper ridge portion 50a and a lower ridge portion 50b. The break 52 in ridge 50 is of sufficient width to receive the aligned ears 26 and 28 of hasp 14 between the upper and lower ridges 50a and 50b (as shown in FIG. 4). A vertically-oriented leg 54 is formed on the lower surface of bottom wall 40 and is vertically aligned with ridge 50, adjacent the front of box 30.

As shown in FIG. 4, a vertical central bore 56 extends upwardly from the lower end of leg 54, through the length of leg 54, through the length of lower ridge portion 50b, and into the lower end of upper ridge portion 50a. Bore 56 has a lower portion 56b having a larger diameter than an upper portion 56a, and receives a conventional push-button type lock 58, well-known in the art. Lock 58 includes a cylinder 60 releasably secured within bore lower portion 56b by a set screw 62. A plunger 64 is slidably mounted within cylinder 60, and includes a lower plug portion 66 and an upper pin portion 68. Plug 66 has a larger diameter than pin 68 such that a spring 70 around pin 68 within bore lower portion 56b will bias the plug 66 downwardly and out of bore 56. Plug 66 is retained in the locked position shown in FIG. 4, by the misalignment of tabs 72 from longitudinal keyways 74 in cylinder 60.

Rotation of plug 66 within cylinder 60 selectively aligns and misaligns the tabs 72 from the keyways 74 to lock and unlock the lock 58, in a fashion known in the art. A key 76 will selectively engage a key slot 78 in the lower exposed face 66a of plug 66 to permit the rotation and locking and unlocking function.

Pin 68 of plunger 64 extends upwardly from and coaxial with plug 66 through the bore upper portion 56a in ridge lower portion 50b and into bore upper portion 56a in ridge upper portion 50a when lock 58 is in the locked position shown in FIG. 4. As shown in the drawing, bore upper portion 56a is located in alignment with the apertures 26 and 28 of hasp ears 22 and 24, respectively, when cover 10 is secured to hasp 14. Thus, pin 68 secures hasp ears 22 and 24 from removal from box 30 when lock 58 is in the locked position. When lock 58 is in the unlocked position shown in FIG. 2, plug 66 will project downwardly and outwardly from the lower end of leg 54, and pin 68 (not seen in FIG. 2) will be withdrawn from the bore upper portion 56a in ridge upper portion 50a and from break 52, to thereby release the hasp ears from securement.

Installation of security cover 10 requires that handle 16 first be moved to a “locked” position placed on the stationary leg 18 of hasp 14, as shown in FIG. 1. Leg 20 is then pivoted over handle 16 to align the apertures 26 and 28 of the associated hasp ears 22 and 24, respectively. Cover 10 is then placed over the hasp 14, with the hasp ears 22 and 24 inserted within the break 52 in ridge 50 (see FIG. 2), and the rearward edge of the box walls in close proximity to the container surface upon which the hasp 14 is mounted. Plug 66 is then pushed vertically upwardly into box 30, from the unlocked position of FIGS. 1 and 2 to the locked position of FIG. 4, such that the lower end of plug 66 is substantially flush with the lower end of leg 54. This, in turn, will cause pin 68 to be journaled through the aligned apertures 26 and 28 of hasp ears 22 and 24, and into the bore upper portion 56a in ridge upper portion 50a.

Once cover 10 is secured in position over hasp 14, it can only be removed by insertion of the appropriate key 76 in slot 78 (as shown in FIG. 4). There is no access to the securement pin 68, because the pin is completely within the confines of box 30. In addition, even the plug 66 is not exposed to tampering, because only the lower end surface is exposed, when in the locked position.

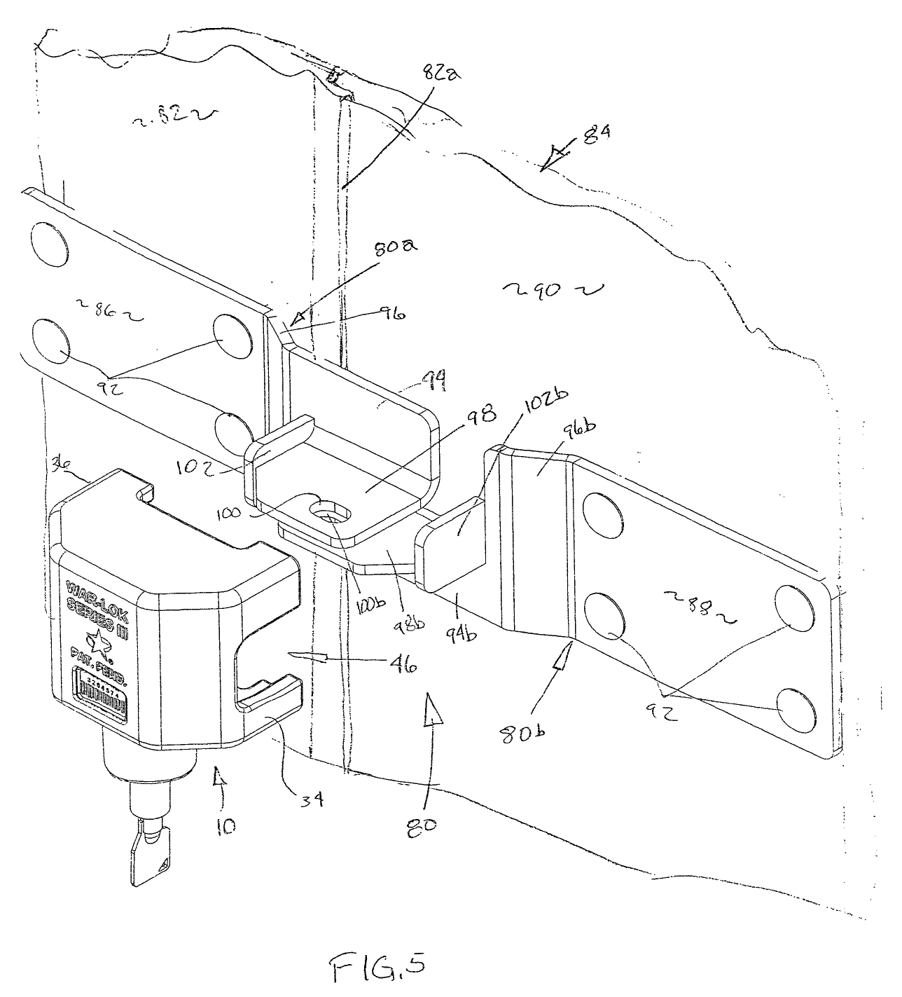

Referring now to FIG. 5, security cover 10 is shown ready for installation on a second embodiment of a hasp assembly 80. Hasp assembly 80 is designed for use on an operable door 82 of a container 84, without the use of an operable handle and keeper bar, as disclosed in the first embodiment shown in FIG. 1. Door 82 is operable to close against container wall 86, and includes a generally vertical outward edge 82a parallel to a hinged edge (not shown).

Security cover 10 is identical to that already described above, and includes a box 30 with sidewalls having openings 46 and 48 therein. Hasp assembly 80 includes a first securement plate 86 mounted on door 82 and a second securement plate 88 mounted on the wall 90 of container 84 adjacent door 82. Securement plates 86 and 88 are secured to their respective structures with fasteners 92 in any conventional fashion which prevents removal from the outside of container 84.

Securement plate 86 includes a wing 94 projecting horizontally and parallel to plate 86, with an upper edge aligned and extending from the upper edge of the plate 86. Wing 94 has a vertical height slightly less than one-half the height of plate 86 and is preferably spaced outwardly away from the door 82 by a sloped arm 96. An ear 98 projects perpendicularly outward from the lower edge of wing 94 and has an aperture 100 therethrough. A gusset 102 is affixed between ear 98 and wing 94 to strengthen the projecting ear 98 and has a shape corresponding to and designed to substantially fill the associated opening 48 in the associated sidewall 36 of box 30.

Securement plate 86, with its associated arm 96, wing 94, ear 98, aperture 100 and gusset 102, forms one half 80a of hasp assembly 80. The opposing half 80b is identical to the first half 80a, but is inverted. For this reason, all of the components of securement plate 88 will be identified as the “B” elements of the first hasp half 80a. It can therefore be seen that hasp second half 80b includes the same arm 96b, wing 94b, ear 98b, aperture 100b and gusset 102b as the hasp first half 80a, but with the second half inverted such that the apertures 100 and 100b are vertically aligned with the ears 98 and 98b spaced slightly apart and parallel and adjacent one another, with securement plates 86 and 88 horizontally aligned.

Securement plate 86 is affixed to door 82 with wing 94 and ear 98 projecting horizontally beyond the outward door edge 82a and over container wall 90, and will swing along with the door 82. Securement plate 88 is affixed to container wall 90 with the outward extent of ear 98b located inwardly of the door edge 82a, such that door 82 will freely swing open and closed without contacting ear 98b.

In use, cover 10 is releasably secured in position on hasp ears 98 and 98b in the same fashion as described in the first embodiment of FIGS. 1-4.

Whereas the invention has been shown and described in connection with the preferred embodiment thereof, many modifications, substitutions and additions may be made which are within the intended broad scope of the appended claims.

What is claimed is:

1. A security cover with a releasable lock, comprising:
a rearwardly opening steel box having a front wall with upper and lower walls and opposing sidewalls all extending rearwardly from the front wall to form an interior space within the box;
said upper and lower walls and opposing sidewalls each having a rearward edge, forming a continuous rearward edge on the box;
said front wall having an inward face within the interior of the box;
a pair of vertically aligned openings formed in the top and bottom walls, extending forwardly towards the front wall from the rearward edges of the top and bottom walls;
a pair of horizontally aligned openings formed in the sidewalls, extending forwardly toward the front wall from rearward edges of the sidewalls;
an operable lock mounted on said box, said lock operable between a locked position securing a vertical pin in a first position securing ears of a hasp within the interior of the box, and an unlocked position permitting vertical movement of the pin to a second position releasing the ears of the hasp.

2. The security cover of claim 1:
wherein said box includes:
a vertical ridge projecting rearwardly from the inward face of the front wall;
said ridge having a horizontal break therein located generally centrally between the upper and lower walls of the box, forming ridge upper and lower portions within the interior of the box;
a vertical bore extending upwardly through the entirety of the ridge lower portion and less than entirely through the ridge upper portion;
wherein said vertical pin is a part of the lock;
wherein the pin extends through the bore in the ridge lower portion, across the break and into the bore in the ridge upper portion when in the locked position; and
wherein the pin extends only into the ridge lower portion, and not across the break when in the unlocked position.

3. The security cover of claim 2, wherein:
said lock is a plunger-type lock with a cylindrical plug coaxially mounted on a lower end of the pin;
said plug operably mounted within a cylinder for movement between a locked position within the cylinder and an unlocked position projected at least partially out of the cylinder;
said box includes a leg depending from the bottom wall thereof, aligned with the ridge;
said bore extending downwardly through the entirety of the leg;
said leg portion of the bore having a diameter greater than that of the bore within the ridge;
said lock cylinder mounted within the leg portion of the bore and oriented with the pin projecting upwardly through the bore in the ridge.

4. In combination:
a cargo container having at least one vertical wall with an operable door mounted therein;
a hasp assembly having at least a portion mounted on the door;
said hasp assembly including first and second hasp ears, each ear having an aperture formed therethrough;
said hasps ears movable relative to one another from a first position with the apertures in the ears aligned, and a second position with the apertures in the ears out of alignment; and
a security cover with a releasable lock, removably connected to the hasp assembly with the hasp ears positioned within an interior of the cover when the hasp ears are in the first position, said security cover comprising:
a rearwardly opening steel box having a front wall with upper and lower walls and opposing sidewalls all extending rearwardly from the front wall to form an interior space within the box within which the hasp ears project;
said upper and lower walls and opposing sidewalls each having a rearward edge, forming a continuous rearward edge on the box;
said front wall having an inward face within the interior of the box;
a pair of vertically aligned openings formed in the top and bottom walls, extending forwardly towards the front wall from the rearward edges of the top and bottom walls;
a pair of horizontally aligned openings formed in the sidewalls, extending forwardly toward the front wall from rearward edges of the sidewalls;
an operable lock mounted on said box, said lock operable between a locked position securing a vertical pin in a first position journaled through the apertures in the hasp ears within the interior of the box, and an unlocked position permitting vertical movement of the pin to a second position releasing the ears of the hasp.

5. The combination of claim 4:
wherein said box includes:
a vertical ridge projecting rearwardly from the inward face of the front wall;
said ridge having a horizontal break therein located generally centrally between the upper and lower walls of the box, forming ridge upper and lower portions within the interior of the box;
said hasp ears projecting within the break between the ridge upper and lower positions, when the ears are in the first position;
a vertical bore extending upwardly through the entirety of the ridge lower portion and less than entirely through the ridge upper portion;
wherein said vertical pin is a part of the lock;
wherein the pin extends through the bore in the ridge lower portion, through the hasp ear apertures within the break and into the bore in the ridge upper portion when in the locked position; and
wherein the pin extends only into the ridge lower portion, and not across the break when in the unlocked position.

6. The combination of claim 5, wherein:
said lock is a plunger-type lock with a cylindrical plug coaxially mounted on a lower end of the pin;
said plug operably mounted within a cylinder for movement between a locked position within the cylinder and an unlocked position projected at least partially out of the cylinder;
said box includes a leg depending from the bottom wall thereof, aligned with the ridge;
said bore extending downwardly through the entirety of the leg;
said leg portion of the bore having a diameter greater than that of the bore within the ridge;
said lock cylinder mounted within the leg portion of the bore and oriented with the pin projecting upwardly through the bore in the ridge.
